(19) United States
(12) Patent Application Publication
(10) Pub. No.: US 2002/0134152 A1
(43) Pub. Date: Sep. 26, 2002

(54) Method and a device for determining the wrap angle

(76) Inventors: Kenneth Grefve, Vasteras (SE); Jorgen Bosson, Vasteras (SE)

Correspondence Address: DYKEMA GOSSETT PLLC, Third Floor West, Franklin Square, 1300 I Street, N.W., Washington, DC, 20005-3306, US

(21) Appl. No.: 10/083,651

(22) Filed: Feb. 27, 2002

Related U.S. Application Data
(60) Provisional application No. 60/272,058, filed on Mar. 1, 2001.

(51) Int. Cl. G01F 15/14; G01N 7/00

(52) U.S. Cl. 73/432.1

(57) ABSTRACT

The present invention relates to a method, a system and a device for determining the wrap angle α of a strip of rolled material over a rotating measuring roll in a system for measuring flatness of the strip by means of said measuring roll, which is having a number of measuring devices for force/pressure registration. Said devices generate measurement output signals Uₚᵢ depending on the contact between the strip and the measuring roll and each signal Uₚᵢ comprises a force signal component U_{Fi}. The device (90) determines the wrap angle α from at least one of the measurement signals U_{Fi} characteristic values. The present invention also provides a computer program product, a computer data signal and a flatness determination signal for accomplishing said objects of the invention.

### CROSS REFERENCE TO RELATED APPLICATIONS

This application is related to provisional application Serial No. 60/272,058, filed Mar. 1, 2001, the teachings of which are incorporated herein by reference.

### TECHNICAL AREA

The invention relates to an invented method, a system, a flatness determination signal, a computer program product, a computer data signal and a device for a measuring system for continuous production of substantially long and flat sheet or strip of material. More particularly it is a method, a computer program product, a computer data signal and a device for determining the wrap angle during the flatness measuring for use in a rolling mill where strip is processed in a rolling operation.

### BACKGROUND ART

In the rolling of strip and sheet materials it is common practice to roll a material to desired dimensions in a rolling mill stand and then normally feed the resulting strip to a coiler. On the coiler, the strip is wound up into a coil. Such coils are then taken off the coiler and after some time has elapsed moved on to subsequent processes such as annealing, slitting, or surface treatment processes and other processes.

The tension in the strip between a mill stand and a coiler is carefully monitored and it is known to measure tension distribution across a strip in order to regulate the flatness of the rolled material. In U.S. Pat. No. 3,481,194 Sivilotti and Carlsson disclose a strip flatness sensor. It comprises a measuring roll over which the strip passes between a mill stand and, for this example, a coiler The measuring roll detects the pressure from the strip at several points across the width of the strip. The pressure represents a measure of the tension in the strip. The measurements of tension in the strip result in a map of flatness in each of several zones across the width of the strip. U.S. Pat. No. 4,400,957 discloses a strip or sheet mill in which tensile stress distribution is measured to characterise flatness. The measures of flatness are compared to a target flatness and a difference between measured flatness and target flatness is calculated, as a flatness error. The flatness error is fed back via a control unit to the actuators of the mill stand, so as to regulate and control flatness in the strip in order to approach a zero flatness error.

Wrap angle, Distributed Force per sensor, Strip tension and Flatness per zone across the width of the strip during rolling is determined by means of the strip tension measurement load cells and a measuring roll, which has a number of force/pressure sensors that are situated in a certain pattern on said roll. The measuring roll is divided in zones. A zone is an area between two planes that are perpendicular relatively the rotational axle of the roll. Each measurement zone has at least one sensor/transducer and each sensor/transducer generates an measurement output signal, a force signal component, depending on the pressure of the flat sheet on to the transducer/sensor.

The wrap angle is an important value when calculating other values of interest. The wrap angle is depending on the radius of the coil on the coiler. The wrap angle will change when the radius of the coil is growing and, therefore, the value of the wrap angle has to be adjusted during the process. It is used for calculating the Distributed Force per sensor on the measuring roll. The quantity strip tension is another calculated value corresponding to the force of the strip against the measuring roll. Strip tension is an important quantity for determining the mean value force on the roller and on each measuring device.

### SUMMARY OF THE INVENTION

It is an object of the invention to suggest an invented method, a system, a flatness determination signal, a computer program product, a computer data signal and a device for determining the wrap angle. It is another object of the invention to suggest a method, a computer program product, a computer data signal and a device that determines a “fresh” and correct value of the wrap angle. It is further an object of the invention to gain a more correct value of the flatness and other force quantities. It is further another object of the invention to provide a method, a computer program product, a computer data signal and a device for determining the wrap angle from at least one of a set of measurement signals U_{Fi} having characteristic values related from at least one of said signals Uₚᵢ. Moreover, it is an object of the invention to provide a method, a computer program product, a computer data signal and a device for determining the wrap angle without using tensiometer load cells, which are fixed at the shaft bearings of a measuring roll, and that is electrically connected to a Strip Tension Measurement System (STMS).

The invention provides an invented method, a system, a flatness determination signal, a computer program product, a computer data signal and a device for determining the wrap angle of a strip of rolled material over a rotating measuring roll, having a number of measuring devices for force/pressure registration, said devices generating measurement output signals Uₚᵢ depending on the contact between the strip and the measuring roll. The invented method comprises a step wherein the wrap angle α is determined from at least one of the measurement signals UFᵢ having characteristic values related from at least one of said signals Uₚᵢ.

The invented method, system, flatness determination signal, computer program product, computer data signal and device are presented in the claims and described in more detail in the description.

The main advantage of the invention is that the wrap angle is determined from at least one of a set of measurement signals U_{Fi} having characteristic values related from at least one of said signals Uₚᵢ.

Another advantage is that the system is not so complex and expensive as prior art devices. It is therefore an advantage of the invention that it provides a method, a computer program product, a computer data signal and a device for determining the wrap angle without using information and/or data generated by tensiometer load cells, which are fixed at the shaft bearings of a measuring roll. A further advantage is that the system uses a “fresh” and correct value of the wrap angle and therefore the system will provide a more correct value of the flatness and other force quantities.

### BRIEF DESCRIPTION OF THE DRAWINGS

The present invention will be described in more detail in connection with the enclosed drawings.

FIG. 1 (Prior art) shows schematically a part of a rolling mill including a flatness measuring roll, a mill stand and a coiler according to the known art.

FIG. 2 (Prior art) shows a simplified block diagram for measuring flatness according to the known art.

FIG. 3 illustrates a measuring roll.

FIG. 4 shows a simplified block diagram of a preferred embodiment of the system.

FIG. 5 is a simplified block diagram of a Flatness Determination Unit, FDU, of the system.

FIG. 6 is a signal diagram showing a force pulse.

FIG. 7 illustrates a preferred embodiment of the invention.

### DESCRIPTION OF THE PREFERRED EMBODIMENTS

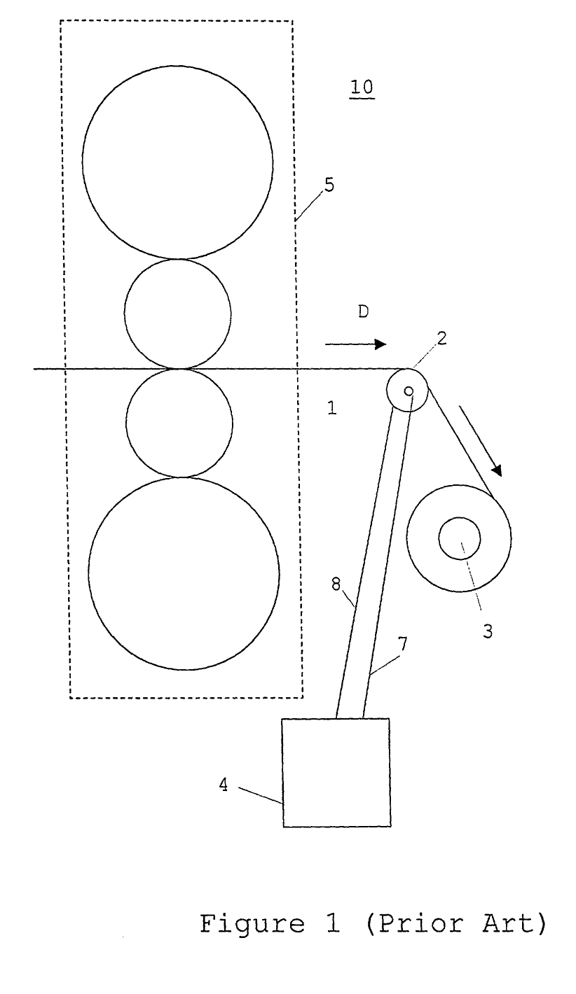

In order to explain the invention, a rolling mill system 10 in the prior art will first be described in summary detail. FIG. 1 (Prior art) shows a metal strip 1 passing through a mill stand 5 in a direction shown by an arrow D. Strip 1 passes over a measuring roll 2 to a coiler 3. Measurement signals from the load cells at the shaft bearings of the measuring roll 2 are connected to the flatness measuring unit 4 via a first measurement connection 7. Measuring devices on the measuring roll 2 are coupled to a flatness measuring unit 4 via a second measurement connection 8. Measurements of the strip corresponding to strip flatness are taken on exit from mill stand 5 by measuring roll 2 before coiling the strip on coiler 3.

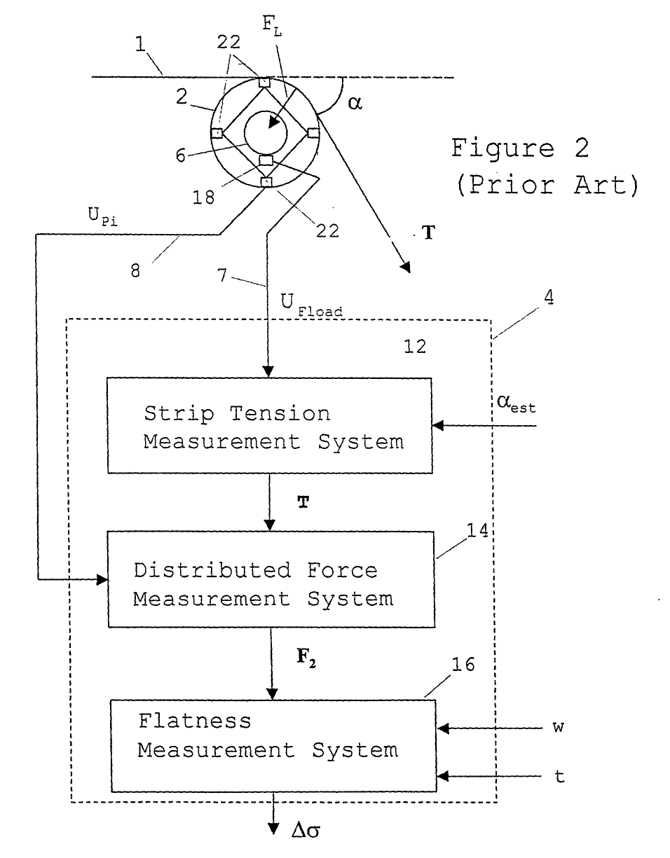

FIG. 2 (Prior art) shows a simplified block diagram for a known system for a flatness measuring unit 4. Said system comprises a Strip Tension Measurement System 12, a Distributed Force Measurement System 14 and a Flatness Measurement System 16. The Strip Tension Measurement System (STMS) 12 is electrically connected to tensiometer load cells 18, which are fixed at the shaft bearings 6 of a measuring roll 2. The load cells 18 generates an input signal U_{Fload} that is transmitted over a first measurement connection 7 to the STMS. Said input signal U_{Fload} is a measured value corresponding to the force FL of the strip against the measuring roll 2. For calculating Strip Tension T, a value for the current wrap angle α of the strip over the roll 2 is needed. The wrap angle α is changing with the increased radius of the coil and the system uses an estimate value αₑₛₜ for the wrap angle. Said estimate value αₑₛₜ and load cell generated value U_{Fload} is used for calculating the strip tension T [N]. The calculated value T is transmitted to Distributed Force Measurement System (DFMS) 14. The measuring roll (2) has a number of force/pressure sensors/transducers that are situated in a certain pattern on said roll. Each sensor/transducer generates an measurement output signal Uₚᵢ depending on the pressure of the flat sheet on to the transducer/sensor. The measurement signals are transmitted to the DFSM 14 via the second measurement connection 8. The DFSM 14 uses the strip tension T and each sensor/transducer signal for determining the Distributed Force F₂ per sensor/transducer. The determined value F₂ is transmitted to Flatness Measurement System (FMS) 16 for determining the Measured Flatness Δσ [N/mm²]. The width w and the thickness t of the system has to be pre-loaded into the FMS.

Flatness per zone across the width of the strip during rolling is determined by means of the measuring roll 2, which has a number of force/pressure sensors that are situated in a certain pattern on said roll. A zone of the roll is a ring formed sector that is parallel with the rotational axle of the roller. Each measurement zone has at least one sensor/transducer and each sensor generates an measurement output signal depending on the pressure of the flat sheet onto the sensor/transducer. The sensors 22 are distributed on the roll in a special pattern. The flatness of the strip 1 will be mapped in parallel lines across the strip perpendicular to the movement direction. If there is a bump or irregularity in the strip, the sensors that come in contact with the bump will register a signal amplitude that differs from the average value generated from other parts of the strip.

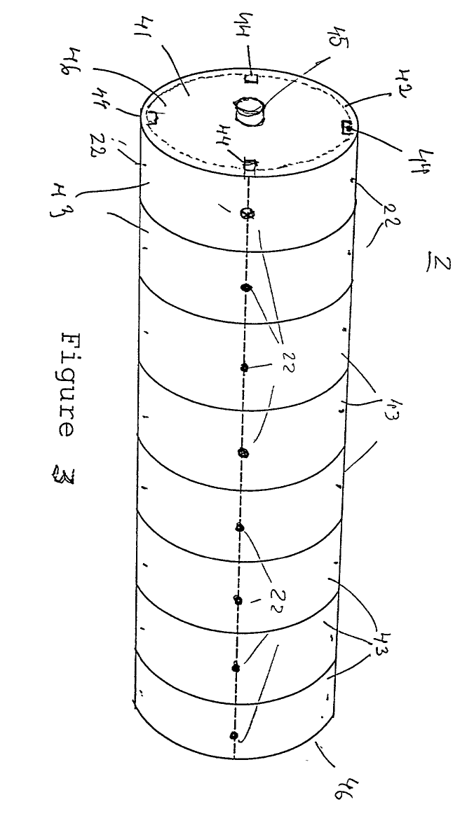

In FIG. 3 an embodiment of a measuring roll 2 is illustrated. It comprises a cylindrical central structure 41, a strip contact device 42 and shaft taps 45. The strip contact device 42 is tightly attached to the structure 41, both having a circular cross-section. The strip contact device 42 of the measuring roll 2 is divided into a number of measurement zones 43, i (i=1, 2, 3 . . . , n). Each zone 43 may correspond to one strip contact ring and all rings together will constitute the strip contact device 42. Each zone 43 is annular and comprises a number of sensors 22. The sensors 22 are sitting in parallel slots 44. The strip contact device 42 comprise metal rings that covers and protects the sensors. The end parts 46 of the measuring roll 2 have a shaft tap 45.

However, the invention is not limited in its use to this described embodiment of measuring roll. The measuring roll 2 may have the force/pressure sensors distributed and organized in any known or unknown pattern on said roll and the measurement zones may have another distribution along the roll. The borders of the zones may be crossing the sensors.

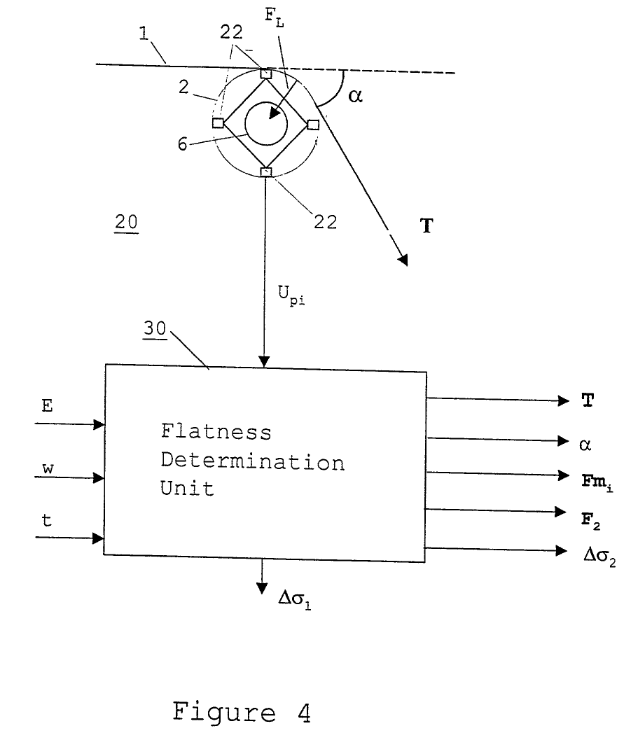

A preferred embodiment according to the invented system will now be described by means of FIG. 4.

Measuring devices comprises force/pressure transducers/sensors/gauges of known types and will in the following of this description be denoted as force/pressure sensor or only sensor.

A system 20 for measuring flatness of a strip 1 of rolled material comprises a measuring roll 2, which has a number of force/pressure sensors 22 that are situated in a certain pattern on said roll. Each sensor 22 generates an measurement output signal Uₚᵢ depending on the pressure of the flat sheet on to the sensor and a Wrap Angle α of the strip on the measuring roll 2. Said system 20 also comprises a Flatness Determination Unit 30, which is arranged for calculating a value corresponding to the wrap angle α based on said measurement output signals Uₚᵢ and, based thereon, the flatness of the strip.

A flatness determination signal may be derived from at least one measurement signal Uₚᵢ. As mentioned herein above, each separate measurement signal Uₚᵢ is generated by a corresponding measuring device of all measuring devices belonging to at least one of all measurement zones of a measuring roll and comprises one or more measurable values for calculating at least one of following quantities or vectors: strip tension vector T, wrap angle α, distributed force vector F₂, force vector Fₘᵢ, flatness vector Δσ₁ [N/mm²] and/or a corresponding quantity flatness vector Δσ₂ [I-unit]. The flatness determination signal is an input signal to a flatness determination unit for calculating at least one of said quantities or vectors. The flatness determination signal comprises a force component signal (U_{Fi}) and said force component signal (U_{Fi}) includes a train of electrical pulses.

A flatness determination signal may be derived by a number of said separate measurement signals Uₚᵢ. Each of said measurement signals includes a train of electrical pulses, which are synchronized and combined to a flatness determination signal for calculating at least one of said quantities or vectors. Different known techniques for combining such signals are possible, for example integration, signal addition, signal subtraction, etc.

The measurement signals Uₚᵢ or flatness determination signals are input signals to the Flatness Determination Unit 30 for calculating the quantities Wrap Angle α, the force vector Fmᵢ for the corresponding measurement zone, Strip Tension T and Distributed Force F₂ on each sensor/transducer, which quantities are used for calculating the flatness Δσ₁ (Δσ₂ is corresponding to relative strain in I-unit) by means of the Flatness Determination Unit 30. No tension measurement load cells are needed for determining the strip force on the measuring roll in the new invented system and all the above listed quantities are provided as output values.

The generated signals Uₚᵢ or the derived flatness determination signals could be characterized as a computer data signal. The signals may be superimposed on a carrier waves for transmission of the signal values and characteristics from the sensors to a signal processing unit for separating and determining said signal values and characteristics, e.g. a value for calculating a flatness vector according to any of Δσ₁, Δσ₂.

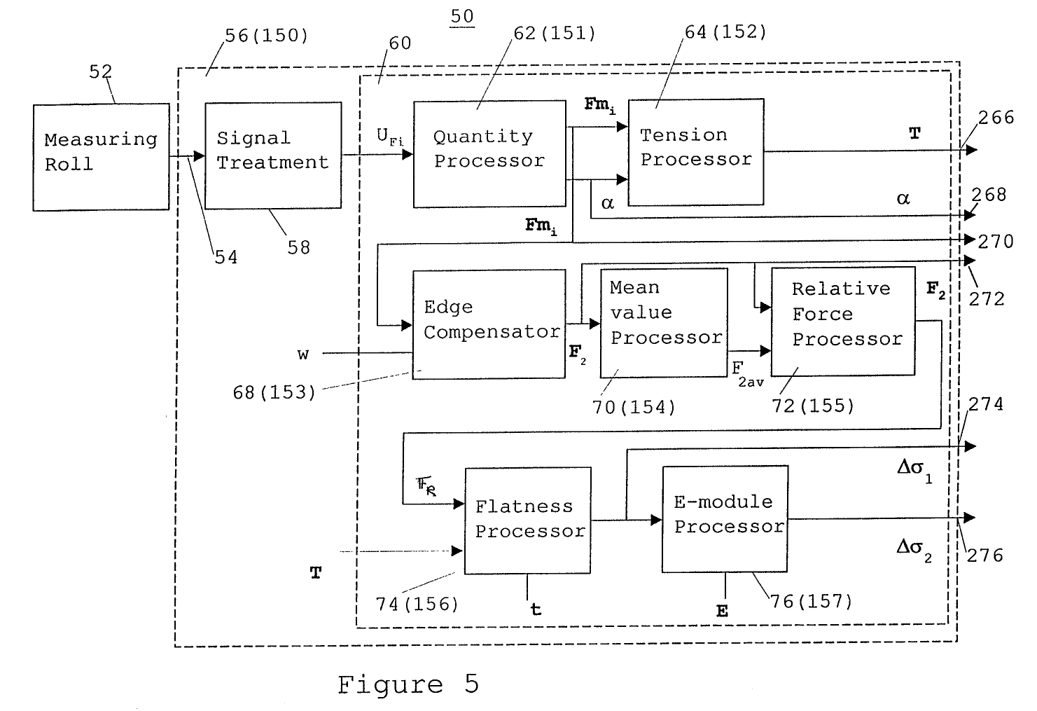

In the following the Flatness Determination Unit, FDU, of a system 50 according to the invention will be described with reference to FIG. 5. As long as each zone and corresponding output signals are treated separately and no mixing or integration over the zones is performed by the system all measurement zones, channels and signal paths of the system are parallel and designed exactly in the same way. Therefore, in the following only one signal path of the measurement system will be described.

Every time a sensor is influenced by the strip passing a voltage or/and current is generated. The input signal to the sensor has a frequency f_{c}. When a force is applied to the measuring roll the input signal becomes a carrier wave that is modulated in proportion to the applied force. The signal may be sampled before it is transmitted to the FDU.

Each sensor having no contact with the strip will generate a noise signal. The FDU has synchronising circuits that generate synchronise pulses indicating the beginning and the end of a time period, called a time slot, during which the contribution from sensors that are in contact with the strip will be integrated. During the time interval when the sensors have no contact with the strip the noise signals will be neglected. The clock circuits also generate clock pulses for synchronisation of the different blocks and processes of the system.

Measurement signals, analogue or digital, will be transmitted from the measurement zones of the measuring roll 52 via the channels 54 to the FDU 56. The FDU 56 will have one input port and one signal treatment device 58 for each channel 54. In this embodiment, the force signal component is Amplitude Modulated (AM) on a carrier wave having the carrier frequency f_{c}. However, a person skilled in the art can chose and apply any transmission method, such as any other modulation method or a method wherein no modulation is done.

One of the tasks of the signal treatment device 58 is to demodulate the input signal. Other signal operations carried out by the signal treatment device 58 are filtering and rectifying.

By multiplying an AM input signal with a rectification signal the input signal will be demodulated. After demodulation, the signal comprises both the force signal component U_{Fi}, a DC component and the carrier wave. The only useful signal is the force signal component U_{Fi}. A connected standard filter will remove the DC component. The signal treatment is finished and the force signal component U_{Fi} is forwarded to the signal processing unit 60 or, shorter, signal processor, of the FDU 50.

The method and signal processing unit 60 for determining different quantities out of the signal treated force signal component U_{Fi} will now be described in more detail.

The output of the signal treatment device 58 is a force signal component U_{Fi} consisting of force pulses. Each pulse of the force signal component contains information about the force and wrap angle. The amplitude Â of each pulse is depending on the force against the signal generating sensor 22 and the length of each pulse is depending on the wrap angle α and the strip velocity. The wrap angle α determines the length of the strip contact area against the measuring roll and the velocity determines the time for a sensor to pass that area.

The first step 151 is to extract and determine the force vector Fmᵢ for the corresponding measurement zone i, i=1, 2, 3, . . . , n and the wrap angle α. This step, 151, is accomplished by a quantity processor block 62. The quantities Fmᵢ and α are forwarded in digital form as signals to a tension processor block 64 that, in step 152, calculates the tension T [N] over the strip by generating the sum of force vectors Fmᵢ for all measuring zones. Said sum is divided by the Sinus value of the wrap angle α, in accordance with the formula

T=τFmᵢ/(2 Sin α/2)

The quantities T, α and Fmᵢ are forwarded in digital form as signals to separate output ports 266, 268 and 270 for further purposes in the rolling mill system, e.g. display. T is also transmitted to a Flatness Processor 74 that will be described further down in this description. The force vector Fmᵢ is forwarded to an edge compensator 68 in the next step 153. Said device/block 68 introduces the width w of the strip and if necessary, the strip position on the measuring roll. The width of the strip varies and for determining the correct flatness value and tension and force distributions, the width variation must be considered. The result of the this calculation is the force distribution vector F₂ [N/mm]. The digital signal representing the quantity F₂ is transmitted to an average generator block 70, a relative force processor 72 and an output port 272. In the following two steps, 154 and 155, an average distribution force F₂ₐᵥ is generated by means of the average generator block 70 and then, the second step 156, calculate the relative force factor

F_{R}=(F₂−F₂ₐᵥ)/F₂ₐᵥ

by means of a relative force processor 72. The flatness vector Δσ₁ [N/mm²] is then calculated by use of a flatness vector generator block 74 in the following step 156. The thickness vector t is used in this step 156 as an input to the generator 74. The flatness vector Δσ₁ is calculated by use of the formula

Δσ₁=F_{R}·(T/w·t)

One further step 157 may be taken—that is to transform the flatness vector Δσ₁ [N/mM²] to a corresponding dimensionless quantity flatness vector Δσ₂ [I-unit]. The flatness vector Δσ₁ [N/mm²] is forwarded to a E-module processor block/step 76/157 and the flatness vector Δσ₂ is generated as an output 280. By dividing the flatness vector Δσ₁ [N/mm²] with the modulus of elasticity E, the corresponding dimensionless flatness vector Δσ₂ is generated. The FDU 56 has a flatness vector Δσ₁ output 274. The quantities Δσ₁ and Δσ₂ are forwarded in digital form as signals to said output ports 274 and 276 for further purposes in the rolling mill system, e.g., control and display purposes.

The method is repeated each time as new information from the measuring devices is received by the Flatness Determination Unit.

The steps, blocks and the devices discussed in the embodiment according to FIG. 5 may be implemented as hardware circuits or as software routines in a processor or central processing unit, CPU.

A Quantity processor is a device for determining the force vector Fmᵢ for the corresponding measurement zone and the wrap angle α of a strip of rolled material over a rotating measuring roll in a system for measuring flatness of the strip by means of said measuring roll. The measuring roll is divided into a number of measurement zones, i=1, 2, 3, . . . , n , each zone i having a number of measuring devices for force/pressure registration and they generate measurement output signals Uₚᵢ depending on the contact between the strip and the measuring roll. Each measurement zone i has a channel 54 for transmitting the generated signal Uₚᵢ from one of the zone sensors. Said system also comprises at least one signal treatment device for processing said signals _{Upi} resulting in a force signal component U_{Fi}. Said channels is connected to a signal treatment device 58. Said signal treatment device is described in FIG. 5 in more detail. The device determines the wrap angle α from at least one of the measurement signals U_{Fi} characteristic values related from at least one of said signals Uₚᵢ. The force contribution from the amplitude of the force pulse will also be determined by the Quantity Processor, but said procedure will not be further described here.

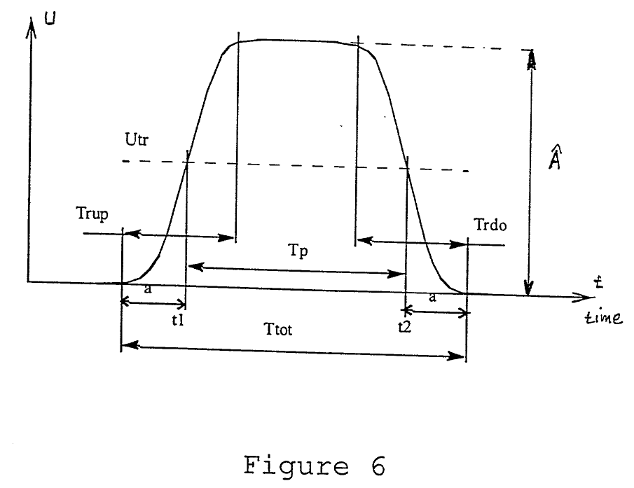

An example of a force signal component U_{Fi} wherein the signal amplitude has the shape of a pulse is illustrated in FIG. 6. The signal has a number of characteristic values e.g. the amplitude Â, a total pulse width Tₜₒₜ and a detected pulse width T_{P}. The pulse width Tₜₒₜ comprises different time intervals like Tᵣᵤₚ that is the rise time of said force pulse, the falling time T_{rdo} of the force pulse. The pulse width Tₜₒₜ and pulse width T_{P} will change when earlier mentioned wrap angle α changes. The wrap angle will change slowly with the slowly increasing radius of rolled material on the coiler 3.

The following description will concentrate on describing how the detected pulse width value T_{P} and the total pulse width value Tₜₒₜ is determined and calculated from a force pulse U_{Fi} illustrated in FIG. 6 by means of an embodiment of the invention illustrated in FIG. 5. The Quantity Processor 62 registers the amplitude and the amplitude variation as a function of time as signal characteristic values of the force signal component U_{Fi} and detects the time points (t₁,t₂) when the force signal component U_{Fi} passes a predetermined threshold value Uₜᵣ.

In this embodiment, Uₜᵣ is chosen to correspond to half the peak value Uₚₑₐₖ, Uₜᵣ=½ Uₚₑₐₖ. This threshold value will generally correspond to a time period exactly or close to half the rise time Tᵣᵤₚ, and if the pulse is symmetric, half the falling time T_{rdo}. The time parameters Tᵣᵤₚ and T_{rdo} is depending on the geometry and the velocity of the measuring roll and are than considered as known or predetermined. In the figure half the rise time Tᵣᵤₚ and falling time T_{rdo} are both defined as time length a. The Quantity Processor 62 detects and determines the total pulse width Tₜₒₜ and the detected pulse width T_{P} of the force signal component U_{Fi} by means of two successive time points t₁ and t₂ and the time length a. The value of the parameter T_{P} is calculated, by use of the formula

T_{P}=t₂−t₁ (1)

and the value of the parameter Tₜₒₜ is calculated, by use of the formula

Tₜₒₜ=t₂−t+2a (2)

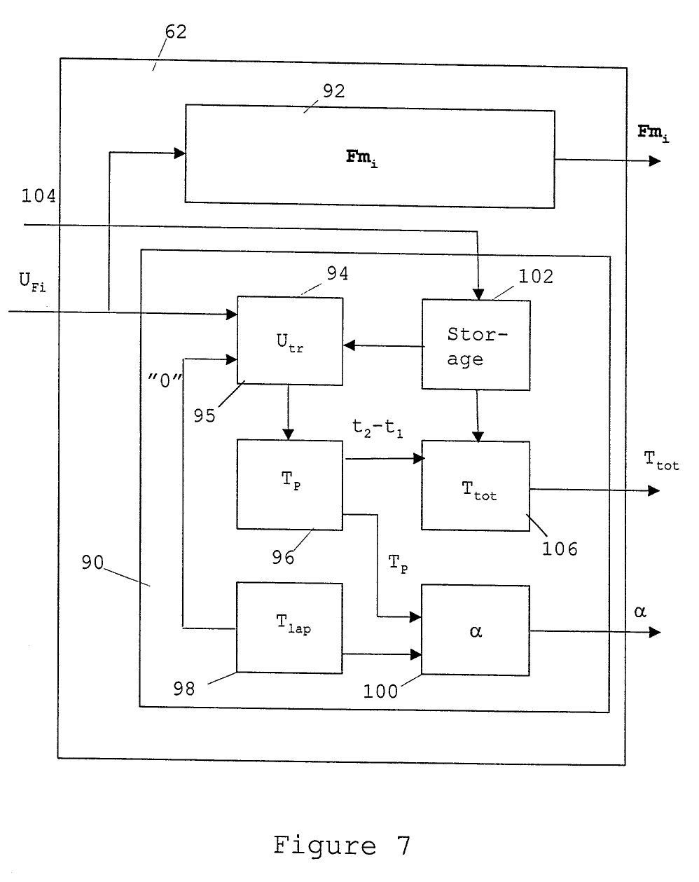

A preferred embodiment of an α Quantity Processor 90 for determining the wrap angle is illustrated in FIG. 7. Said α Quantity Processor 90 is a part of the Quantity Processor 62, which also comprises a force vector Fmᵢ Quantity Processor 92 for determining the force contribution from the amplitude of the force pulse UFᵢ, but said processor or procedure will not be further described here. The following description will concentrate on describing how the wrap angle is determined and calculated. The device 90 comprises a means 94 for registering the amplitude and the amplitude variation implemented as a threshold means 94 for detecting a first threshold time point t₁ and a second threshold time point t₂ when at least one of the force signal components U_{Fi} or a signal, like a mean value signal U_{A}, related to said generated signals passes a predetermined threshold value Uₜᵣ. The threshold means 94 may be implemented as a comparating function and a time counting function, either in hardware or in software. The threshold means 94 has a reset input 95. An external or internal reset signal on the reset input resets the time counting to zero for each start of a new lap of the measuring roll. In this embodiment, an internally applied Tₗₐₚ block 98 generates the reset signal. An internal counter of the threshold device 94 will start counting from zero when a reset signal “0” is received. When an edge, rising or falling, of at least one of the force signal components U_{Fi} passes a predetermined threshold value Uₜᵣ, the threshold means 94 detects the first or second threshold time, t₁ or t₂, and forwards the detected time value to a first input of a detected pulse width T_{P} calculating means, 96, for determining the time T_{P} between the two succeeding time points t₁ and t₂. The detected pulse width T_{P} is calculated by use of the equation

T_{P}=t₂−t₁ (1).

When T_{P} is calculated, the value is forwarded from a first output of the T_{P} calculating means to a first input of a wrap angle calculating block 100. Said block 100 has also a second input for receiving a value Tₗₐₚ, which is corresponding to the velocity of the strip. Said value may be received either from an internal block 98 or an external block. In this embodiment, the internally applied Tₗₐₚ block 98 provides the Tₗₐₚ value. The wrap angle calculating block 100 uses the formula,

α=f(T_{P},Tₗₐₚ) (3).

One example of a function is α=T_{P}/Tₗₐₚ. The calculated wrap angle value is delivered to a second output of the Quantity Processor 62 for use in the system.

The wrap angle may be calculated by means of a microprocessor and a suitable calculation computer program. Alternatively, a microprocessor and a Look-Up Table may be used. In the Look-Up Table possible values of the pulse width are stored and each value of the pulse width will correspond to a value of the wrap angle α.

The method is repeated each time as new information from the measuring devices is received by the Flatness Determination Unit.

The value Uₜᵣ is stored in a storage 102. A new threshold value may be loaded via a storage data bus 104 into the storage 100 that will load the new threshold value via a threshold value input of the threshold means.

A block 106 for calculating a value of the total pulse width Tₜₒₜ is also provided in this embodiment of an α Quantity Processor. From a second output of the detected pulse width T_{P} calculating means, 96, is forwarded the difference t₂−t₁=T_{P} to a first input of the total pulse width Tₜₒₜ calculating block. Tₜₒₜ is calculated by use of the earlier mentioned equation (2). The needed parameter “a” is provided by the storage means 102. The calculated total pulse width value is delivered to a third output of the Quantity Processor 62 for use in the system.

Instead of a means 94 for registering the amplitude and the amplitude variation, an α Quantity processor 90 may comprise means 94′ for registering and detecting any other signal characteristic value of a signal, e.g. phase, phase deviation and frequency, if said signal characteristic value of the force signal component U_{Fi} carries information for determining the wrap angle α.

If the measuring device generated signals Uₚᵢ includes noise with interfering noise characteristics, like amplitude, said system may comprise means for generating a mean value signal U_{A} from at least a number of the signals Uₚᵢ corresponding to measurement devices positioned in parallel rows along the rotation axis of the measuring roll. The Quantity processor should be provided with means for detecting the moment when the mean value signal U_{A} passes a predetermined threshold value Uₜᵣ.

The mean value signal U_{A} will consist of force pulses, as signal U_{Fi}, and the detected pulse width can be determined by calculating the formula (2),

T_{P}=t₂−t₁

wherein T_{P} is the time/width and between two succeeding passings of a threshold value and the device also comprises means for calculating the wrap angle as a function of the detected pulse width T_{P} and the total pulse width Tₜₒₜ.

The total time Tₜₒₜ by means of two successive time points t₁ and t₂ of the threshold value. The time parameters a, Tᵣᵤₚ and T_{rdo} depends on the geometry of the measurement roll and are known and are read from the data storage 102. If Uₜᵣ is chosen to correspond to half the peak value Uₚₑₐₖ, Uₜᵣ=½Uₚₑₐₖ, a corresponds to half the rise time or falling time, Tₜₒₜ is calculated using

Tₜₒₜ=t₂−t₁+2a (2)

and all parameters of equation (1) is known.

The method is repeated each time as new information from the measuring devices is received by the Flatness Determination Unit.

All the described means of the wrap angle processor are preferably implemented as software blocks, stored in a memory that is accessible from a microprocessor. Therefore, the present invention also is a computer program product containing computer program code elements or software routines that when run on a computer or processor causes said computer or processor to carry out the steps of a method according to any of claims 1-8.

Further, one embodiment of the invention is a computer program product according to claim 17, wherein the wrap angle is calculated according to any of claim 5 or 8.

Another embodiment of the invention is a computer program product defined by claim 17, wherein the wrap angle is determined by use of one or more values stored in a Look-Up Table.

Moreover, one embodiment of the invention is a computer program product according to claim 19, wherein one or more values stored in said Look-Up Table comprises a pulse width.

The invention relates also to a computer data signal comprising a value for flatness vector according to any of Δσ₁ and Δσ₂.

Another embodiment of the computer data signal is a computer data signal comprising a value for a wrap angle, α, dependent on Tₚ and Tₗₐₚ.

Said computer data signal may be superimposed on a carrier wave.

It is an advantage of the invention that it provides a method, a computer program product, a computer data signal and a device for determining the wrap angle without the use of information from one or more signals generated by tensiometer load cells, which are fixed at the shaft bearings of a measuring roll.

The present invention is not limited to the above-described preferred embodiments. Various alternatives, modifications and equivalents may be used. Therefore, the above embodiments should not be taken as limiting the scope of the invention, which is defined by the appended claims.

1. A method for determining the wrap angle of a strip of rolled material over a rotating measuring roll, having a number of measuring devices for force and pressure registration, said devices generating measurement output signals (U_{Pi}) depending on the contact between the strip and said devices of the measuring roll, each of said signals (U_{Pi}) having a force signal component (U_{Fi}), comprising the step of:
determining the wrap angle (α from at least one of the measurement signals (U_{Fi}) having characteristic values derived from at least one of said signals (Uₚᵢ).

2. The method according to claim 1, further comprising the step of:
registering amplitude and amplitude variation as a function of time as signal characteristic values of the force signal components (U_{Fi}).

3. The method according to claim 1, further comprising the step of:
detecting time points (t₁,t₂) when at least one of the force signal components (U_{Fi}) or a signal derived from said generated signals exceeds or falls below a predetermined threshold value (Uₜᵣ).

4. The method according to claim 3, further comprising the step of:
calculating a detected pulse width (T_{P}) by means of two successive time points at which at least one of the force signal components (U_{Fi}) or a signal derived from said generated signals exceeds or falls below a predetermined threshold value (Uₜᵣ).

5. The method according to claim 1, further comprising the steps of:
calculating a detected pulse width of a force pulse of a force signal component (U_{Fi}) according to the equation
T_{P}=t₂−t₁
wherein detected pulse width T_{P} is the measured and calculated time between two succeeding passings of a threshold value; and
calculating the wrap angle as a function of the detected pulse width T_{P} and a value Tₗₐₚ, corresponding to the velocity of the measuring roll.

6. The method according to claim 1, further comprising the step of:
detecting any of the quantities phase, phase deviation and frequency as signal characteristic values of the force signal component (U_{Fi}) for determining the wrap angle α.

7. The method according to claim 1, further comprising the steps of:
generating a mean value signal (U_{A}) from at least a number of the signals (Uₚᵢ) corresponding to measurement devices positioned in parallel rows along the rotation axis of the measuring roll; and
detecting the moment when the mean value signal (U_{A}) passes a predetermined threshold value (Uₜᵣ).

8. The method according to claim 1, further comprising the steps of:
generating a mean value signal (UA) from at least a number of the signals (Upi) corresponding to measurement devices positioned in parallel rows along the rotation axis of the measuring roll;
detecting the moment when the mean value signal (U_{A}) passes a predetermined threshold value (Uₜᵣ);
calculating the detected pulse width of a force pulse of the mean value signal (U_{A}) according to the equation
T_{P}=t₂−t₁,
wherein T_{P} is the detected time between two succeeding passings of the threshold value, t₁ and t₂ are the two detected time points when the mean value signal (U_{A}) passes a predetermined threshold value (Uₜᵣ); and
calculating the wrap angle as a function of the detected pulse width T_{P} and a value Tₗₐₚ, corresponding to the velocity of the measuring roll.

9. A device for determining the wrap angle α of a strip of rolled material over a rotating measuring roll in a system for measuring flatness of the strip by means of said measuring roll, having a number of measuring devices for force/pressure registration, said devices generating measurement output signals Uₚᵢ depending on the contact between the strip and said devices of the measuring roll, each of said signals (Uₚᵢ) having a force signal component (U_{Fi}), wherein the device includes means for determining the wrap angle α from at least one of the force signal components (U_{Fi}) having characteristic values derived from at least one of said signals (Uₚᵢ).

10. A device according to claim 9, further comprising means for registering the amplitude and the amplitude variation as a function of time as signal characteristic values of the force signal components (U_{Fi}).

11. A device according to claim 9, further comprising: means for detecting time points (t₁,t₂) when at least one of the force signal components (U_{Fi}) or a signal derived from said generated signals exceed or falls below a predetermined threshold value (Uₜᵣ).

12. A device according to claim 11, further comprising means for calculating a detected pulse width T_{P} by means of two successive time points (t₁,t₂) at which at least one of the force signal components (U_{Fi}) or a signal derived from said generated signals exceeds or falls below a predetermined threshold value (Uₜᵣ).

13. A device according to claim 9, further comprising means for calculating the pulse width of a force pulse of a force signal component (U_{Fi}) according to the equation
T_{P}=t₂−t₁,
wherein T_{P} is the detected pulse width between two succeeding passings of a threshold value, t₁ and t₂ are a first and a second detected time point when the signal (U_{Fi}) passes a predetermined threshold value (Uₜᵣ), and means for calculating the wrap angle as a function of the detected pulse width (T_{P}) and a value Tₗₐₚ, corresponding to the velocity of the measuring roll.

14. A device according to claim 9, further comprising: means for detecting any of the quantities phase, phase deviation and frequency as signal characteristic values of the force signal component U_{Fi} for determining the wrap angle α.

15. A device according to claim 10, further comprising: means for generating a mean value signal (U_{A}) from at least a number of the signals (Uₚᵢ) corresponding to measurement devices positioned in parallel rows along the rotation axis of the measuring roll, and means for detecting the moment when the mean value signal (U_{A}) passes a predetermined threshold value (Uₜᵣ).

16. A device according to claim 15, further comprising: means for generating a mean value signal (U_{A}) from at least a number of the signals (Uₚᵢ) corresponding to measurement devices positioned in parallel rows along the rotation axis of the measuring roll, means for detecting the moment when the mean value signal (U_{A}) passes a predetermined threshold value (Uₜᵣ), means for calculating the pulse width of a force pulse of the mean value signal U_{A} according to the equation
T_{P}=t₂−t₁,
wherein T_{P} is the detected time between two succeeding passings of a threshold value, t₁ and t₂ are a first and a second detected time point when the mean value signal (U_{A}) passes a predetermined threshold value (Uₜᵣ), and means for calculating the wrap angle as a function of the detected pulse width T_{P} and a value Tₗₐₚ, corresponding to the velocity of the measuring roll.

17. A computer program product for determining the wrap angle of a strip of rolled material containing computer program code elements or software routines that when run on a computer or processor causes said computer or processor to carry out the steps of a method according to claim 1.

18. A computer program product according to claim 17, wherein the wrap angle is calculated according to claim 5, further comprising the steps of:
calculating a detected pulse width of a force pulse of a force signal component (U_{Fi}) according to the equation
T_{P}=t₂−t₁,
wherein detected pulse width T_{P} is the measured and calculated time between two succeeding passings of a threshold value; and
calculating the wrap angle as a function of the detected pulse width T_{P} and a value Tₗₐₚ, corresponding to the velocity of the measuring roll.

19. A computer program product according to claim 17, wherein the wrap angle is determined by use of one or more values stored in a Look-Up Table.

20. A computer program product according to claim 19, wherein the one or more values stored in Look-Up Table comprises a pulse width.

21. A computer data signal for determining the wrap angle of a strip of rolled material, wherein the signal comprises a value for calculating any of flatness vector Δσ₁ or Δσ₂, and wrap angle α dependent on Tₚ and Tₗₐₚ.

22. A computer data signal, wherein the signal is superimposed on a carrier wave.

23. A system for measuring flatness of the strip by means of a measuring roll, having a number of measuring devices for force and pressure registration, said devices generating measurement output signals Uₚᵢ depending on the contact between the strip and said devices of the measuring roll, each of said signals (Uₚᵢ) having a force signal component (U_{Fi}), comprising a device for determining the wrap angle α of a strip of rolled material over a rotating measuring roll and said device is arranged with means for determination of the wrap angle α from at least one of the force signal components (U_{Fi}) having characteristic values derived from at least one of said signals (Uₚᵢ).

24. A system according to claim 23, further comprising: means for registering the amplitude and the amplitude variation as a function of time as signal characteristic values of the force signal components (U_{Fi}).

25. A system according to claim 23, further comprising: means for detecting time points (t₁,t₂) when at least one of the force signal components (U_{Fi}) or a signal derived from said generated signals exceed or falls below a predetermined threshold value (Uₜᵣ).

26. A system according to claim 25, further comprising means for calculating a detected pulse width T_{P} by means of two successive time points (t₁,t₂) at which at least one of the force signal components (U_{Fi}) or a signal derived from said generated signals exceeds or falls below a predetermined threshold value (Uₜᵣ).

27. A system according to claim 23, further comprising: means for calculating the pulse width of a force pulse of a force signal component (U_{Fi}) according to the equation
T_{P}=t₂−t₁,
wherein T_{P} is the detected pulse width between two succeeding passings of a threshold value, t₁ and t₂ are a first and a second detected time point when the signal (U_{Fi}) passes a predetermined threshold value (Uₜᵣ), said device also comprises means for calculating the wrap angle as a function of the detected pulse width (T_{P}) and a value Tₗₐₚ, corresponding to the velocity of the measuring roll.

28. A system according to claim 23, further comprising means for detecting any of the quantities phase, phase deviation and frequency as signal characteristic values of the force signal component U_{Fi} for determining the wrap angle α.

29. A system according to claim 24, further comprising: means for generating a mean value signal (U_{A}) from at least a number of the signals (Uₚᵢ) corresponding to measurement devices positioned in parallel rows along the rotation axis of the measuring roll, said device also comprises means for detecting the moment when the mean value signal (U_{A}) passes a predetermined threshold value (Uₜᵣ).

30. A system according to claim 29, further comprising: means for generating a mean value signal (U_{A}) from at least a number of the signals (Uₚᵢ) corresponding to measurement devices positioned in parallel rows along the rotation axis of the measuring roll, means for detecting the moment when the mean value signal (U_{A}) passes a predetermined threshold value (Uₜᵣ), and means for calculating the pulse width of a force pulse of the mean value signal U_{A} according to the equation
T_{P}=t₂−t₁,
wherein T_{P} is the detected time between two succeeding passings of a threshold value, t₁ and t₂ are a first and a second detected time point when the mean value signal (U_{A}) passes a predetermined threshold value (Uₜᵣ), and means for calculating the wrap angle as a function of the detected pulse width T_{P} and a value Tₗₐₚ, corresponding to the velocity of the measuring roll.

31. A flatness determination signal derived from at least one measurement signal (Uₚᵢ) for determining the wrap angle of a strip (1) of rolled material over a rotating measuring roll (2), characterized in that each separate measurement signal (Uₚᵢ) is generated by a corresponding measuring device of all measuring devices belonging to at least one of all measurement zones of a measuring roll comprising: one or more measurable values for calculating at least one of strip tension vector T, wrap angle α, distributed force vector F₂, force vector Fmᵢ flatness vector Δσ₁ N/mm² and/or a corresponding quantity flatness vector Δσ₂ I-unit.

32. A flatness determination signal according to claim 31, wherein said flatness determination signal is an input signal to a flatness determination unit for calculating at least one of said quantities or vectors.

33. A flatness determination signal according to claim 32, wherein said flatness determination signal comprises a force component signal (U_{Fi}).

34. A flatness determination signal according to claim 33, wherein said force component signal (U_{Fi}) includes a train of electrical pulses.

35. A flatness determination signal according to claim 31, wherein a number of said separate measurement signals (Uₚᵢ), each includes a train of electrical pulses synchronised and combined to a flatness determination signal for calculating at least one of said quantities or vectors.
